(19) United States
(12) Patent Application Publication
(10) Pub. No.: US 2006/0131780 A1
(43) Pub. Date: Jun. 22, 2006

(54) Resin casting mold and method of casting resin

(75) Inventors: Takaki Kuno, Kyoto-shi (JP); Keiji Maeda, Kyoto-shi (JP)

Correspondence Address: BIRCH STEWART KOLASCH & BIRCH, PO BOX 747, FALLS CHURCH, VA, 22040-0747, US

(73) Assignee: TOWA CORPORATION

(21) Appl. No.: 11/290,559

(22) Filed: Dec. 1, 2005

(30) Foreign Application Priority Data
Dec. 17, 2004 (JP) 2004-365973 (P)

(51) Int. Cl. B29C 41/42

(52) U.S. Cl. 264/236; 264/334; 425/444

(57) ABSTRACT

A resin casting mold used for manufacturing a casting product including a cured resin produced by curing a fluid resin filling a cavity includes: a block providing the bottom surface of the cavity; and a driver mechanism for applying a force to the block to move the block in a direction that lies along the bottom surface. The driver mechanism moves the block when the cured resin has been formed to separate the cured resin from the bottom surface. This arrangement allows a thinner casting product with a larger major surface to be properly separated from the cavity surface without damaging the casting product and with high driving efficiencies and without equipment including a resin casting mold with a complicated structure or a large size.

This nonprovisional application is based on Japanese Patent Application No. 2004-365973 filed with the Japan Patent Office on Dec. 17, 2004, the entire contents of which are hereby incorporated by reference.

### BACKGROUND OF THE INVENTION

1. Field of the Invention

The present invention relates to a resin casting mold and a method of casting a resin where a fluid resin filling a cavity is cured to produce a casting product.

2. Description of the Background Art

Conventionally, a resin casting mold is employed for manufacturing castings by curing a fluid resin filling a cavity. Such a mold provides a cured resin within a cavity, thereby providing a casting product including the cured resin.

Subsequently, the casting product is removed from the mold. For this purpose, an ejector mechanism (see Japanese Utility Model Laying-Open No. 2-36039, FIG. 9, for example) is utilized, which includes: an ejector plate(s) separate from the mold below and/or above the mold which can be moved upward and downward; and an ejector pin attached to the ejector plate(s) which can be moved together with the ejector plate(s) to eject the casting product.

Some resin casting molds allow a casting to be removed from it without an ejector mechanism. A resin casting mold without an ejector mechanism will now be discussed.

For example, Japanese Utility Model Laying-Open No. 2-36039, FIGS. 1 and 2, discloses a mechanism in which a hole and a valve pin are provided on a cavity and, during the opening of the mold, the valve pin is removed to leave the hole open through which a high-pressure fluid, such as compressed air, is jetted toward the casting to remove the casting off the cavity surface.

Japanese Patent Laying-Open No. 5-326597, pages 5 to 6 and FIG. 1, discloses a mechanism in which the surface of a cavity is vibrated to remove the casting off the cavity. The vibration is applied to the cavity surface by a vibration generator separate from the mold at amplitudes ranging from about 1 to 2 μm.

Japanese Patent Laying-Open No. 2004-223866, pages 4 to 6 and FIGS. 1 to 4, discloses a mechanism including a piezoelectric material attached to the mold to provide the cavity surface as well as a driver for deforming the piezoelectric material by expansion or contraction. The piezoelectric material is deformed in a direction that lies along the cavity surface from the center of the cavity toward the outside, or a direction that crosses the cavity surface, for example perpendicular thereto.

Unfortunately, the above conventional techniques have the following problems:

A mechanism using an ejector pin to eject the casting requires a space in which the ejector plate can be moved upward and downward, making it impossible to provide smaller resin casting equipment including a mold.

A mechanism in which high pressure fluid is jetted toward the casting requires a compressor, a high-pressure fluid tank, tubing and more, again making it impossible to provide smaller resin casting equipment including a mold.

A mechanism in which the resin casting mold is vibrated to remove the casting off the cavity surface requires vibration to occur throughout the entire resin casting mold rather than merely where the casting sticks to the cavity surface, which leads to lower driving efficiencies and also results in resin casting equipment including a resin casting mold with a complicated structure. Further, some fluid resins have properties that may prevent a casting product including a cured resin from being efficiently separated from the cavity surface when, for example, the cured resin firmly sticks to the cavity surface.

In the case that a piezoelectric material is deformed in a direction that lies along the cavity surface from the center of the cavity toward the outside, it is difficult to reduce the degree of sticking of the casting to the cavity surface around the center of the cavity. When the piezoelectric material is deformed in a direction crossing the cavity surface, the deformation of the piezoelectric material may damage the casting, which would reduce the quality of the casting.

In manufacturing of packages for electronics by resin-sealing a chip-like device (hereinafter referred to as a “chip”) constructed by, for example, a semiconductor chip which is mounted on, for example, a printed board (hereinafter referred to as a “board”), recent trends include thinner packages (and thus thinner casting products), more devices produced per substrate (and thus larger casting products) from cost considerations, and increased degree of sticking of the cured resin for the purpose of ensuring reliability of smaller packages. The above gives rise to the following application-specific problems:

For example, a mechanism with an ejector pin may cause a crack in a thinner casting product (board and cured resin). Breaking or improper connection may also occur in wires connecting the chip and the board. All this contributes to reduced reliability and yield of the end product, i.e. electronic component. Moreover, larger major surface of the casting product requires increased number of ejector pins, resulting in equipment including a resin casting mold with a complicated structure.

A mechanism in which high pressure fluid is jetted toward the casting product requires a larger fluid pressure as the major surface of the casting product and the degree of sticking of the cured resin to the cavity surface are increased. Consequently, a crack may occur in thinner casting products. Moreover, increasing the number of holes through which the high pressure fluid is jetted toward the casting product results in equipment including a resin casting mold with a complicated structure, similar to the case of increasing the number of ejector pins.

In a mechanism with a vibrated resin casting mold, separating the casting product off the cavity surface becomes more difficult as the major surface of the casting product and the degree of sticking of the cured resin to the cavity surface are increased. Further, since the vibration is externally applied to the resin casting mold, the cured resin in the cavity and the resin casting mold belong to the same vibration system, which means that an increased amplitude provides substantially no improvement in the separation of the cured resin since the shearing force acting upon the sticking plane between the cavity surface and the casting product is derived solely from inertial force from the vibration.

In the case that the piezoelectric material providing the cavity surface is deformed, it becomes more difficult to separate the casting product from the resin casting mold as the major surface of the casting product and the degree of sticking of the cured resin to the cavity surface are increased. Further, deforming the piezoelectric material in a direction crossing the cavity surface may cause a crack in a thinner casting product.

### SUMMARY OF THE INVENTION

The present invention solves the above problems. An object of the present invention is to provide a resin casting mold and a method of casting a resin in which a thinner casting product with a larger major surface can be properly separated from a cavity surface without damaging the casting product and with high driving efficiencies and without equipment including a resin casting mold with a complicated structure or a large size.

The term “separation” used herein means “transition from a cured resin sticking to a cavity surface to the resin not sticking to the cavity surface”.

A resin casting mold of the present invention is used for manufacturing a casting product including a cured resin produced by curing a fluid resin filling a cavity, the mold including: a block providing a bottom surface of the cavity; and a driver mechanism for applying a force to the block to move the block in a direction that lies along the bottom surface. The driver mechanism moves the block when the cured resin has been formed to separate the cured resin from the bottom surface.

A method of casting a resin according to the present invention includes the steps of: filling a cavity with a fluid resin; curing the fluid resin; and, by moving a block providing a bottom surface of the cavity in a direction that lies along the bottom surface, separating the cured resin from the bottom surface.

According to the present invention, the casting product is separated from the resin casting mold without ejecting the casting product, in other words, without applying a force in the thickness direction of the casting product. This provides the following advantages: A mechanism to eject a casting is not necessary, resulting in a simplified structure of equipment including a resin casting mold. Also, the stress in the thickness direction of the casting product is reduced, such that the quality of casting products, especially those with a large major surface and smaller thickness, is less likely to be adversely affected. Further, a shearing stress is effected across the sticking plane between the cured resin and the cavity, making it easier to separate the casting product from the resin casting mold.

The driver mechanism desirably moves the block while the resin casting mold is being opened. That is, the step of separating desirably moves the block while the resin casting mold is being opened.

Thus, with the cured resin sticking to the bottom surface, a shearing stress and a tensile stress between the bottom surface and the cured resin act to separate the cured resin from the bottom surface, making it easier to remove the casting product off the cavity.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a partial cross section of a resin casting mold of a first embodiment, where the mold is open and a board with a chip mounted upon it is placed on an upper mold.

FIG. 2 is a partial cross section of the resin casting mold where the mold has been closed and a cured resin is formed and the chip and other elements on the board are resin-sealed.

FIG. 3 is a partial cross section of the mold where, starting from FIG. 2, the block is moved to separate the cured resin from the block,

FIG. 4 is a partial cross section of the resin casting mold where the mold is opened and the cured resin with the chip and other elements resin-sealed therein is removed off the cavity.

It should be noted that each of the above figures is schematically drawn with exaggeration for convenience of illustration.

### DESCRIPTION OF THE PREFERRED EMBODIMENTS

### First Embodiment

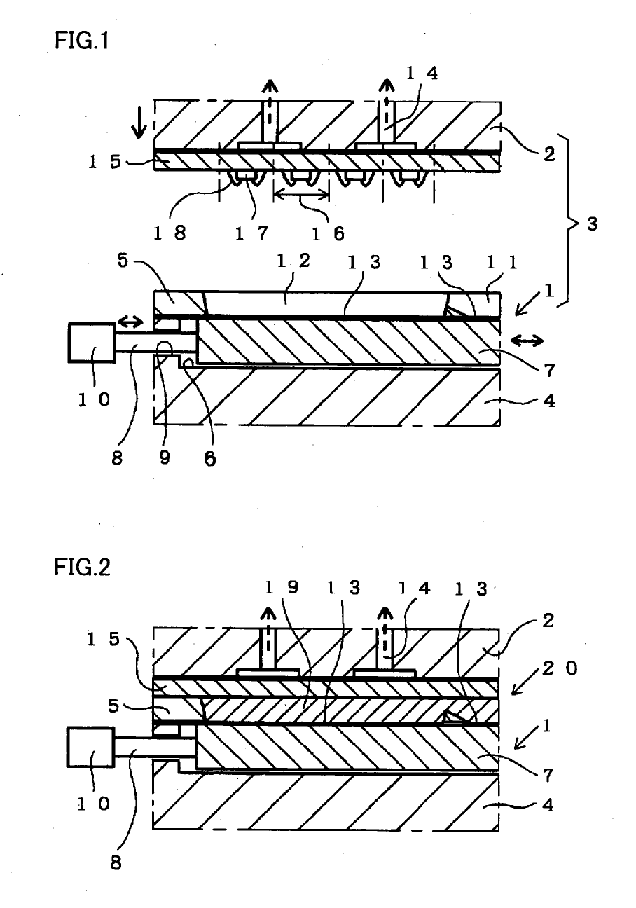

First, referring to FIGS. 1 to 4, a resin casting mold and a method of casting a resin according to a first embodiment of the present invention will be described. Description will be made of a method of casting a resin for manufacturing a package for a plurality of electronic components where transfer molding is employed to resin-seal a plurality of chips mounted on one board. Thus, a casting product of the present invention is a group of a plurality of packages of the present embodiment.

As shown in FIG. 1, a resin casting mold 3 of the present embodiment includes a lower mold 1 and an upper mold 2 opposite to lower mold 1, and is used in resin-sealing employing transfer molding.

Lower mold 1 includes a base 4, an opposing member 5 secured to base 4 and opposite to upper mold 2, a recess 6 provided in base 4, and a block 7 placed within recess 6 and slidable in a horizontal direction. A rod 8 is secured to a side of block 7 and to a driver mechanism 10 via a hole 9 in base 4.

In the present embodiment, driver mechanism 10 moves rod 8 to the left and right in the horizontal direction in the figures and may be an actuator having, for example, an air cylinder or a hydraulic cylinder utilizing fluid pressure, for example.

With opposing member 5 being attached to lower mold 1, lower mold 1 defines a runner 11 i.e. a space through which a fluid resin can flow, and a cavity 12 i.e. a space that can be filled with the fluid resin, where runner 11 communicates with a known resin supplying means (not shown) constructed by, for example, a pot (not shown) incorporating a plunger (not shown).

In the resin casting mold of the present embodiment, a portion of the upper surface of block 7 forms bottom surface 13 of cavity 12 while a portion of the side of the throughhole in opposing member 5 forms the side of cavity 12. Further, another portion of the upper surface of block 7 forms bottom surface 13 of runner 11 while another portion of the side of the throughhole in opposing member 5 forms the side of runner 11.

A suction mechanism 14 is provided on upper mold 2 and is connected via a valve (not shown) with, for example, a vacuum tank (not shown) external to resin casting mold 3. A board 15 is secured to upper mold 2 using suction mechanism 14. On board 15, a chip 17 is mounted in each of a plurality of regions 16 that are arranged in a grid, and the electrodes (not shown) of chip 17 are connected with the electrodes (not shown) of board 15 by a wire 18. What is defined within each of regions 16 becomes one electronic component. It should be noted that while four columns of regions 16 are provided on board 15 in FIG. 1, a substantially larger number of columns of regions 16 may be provided in practice.

In conjunction with the use of a board 15 with a larger surface as described to form a thinner casting product, it is desirable to minimize the stress in the thickness direction of casting product 20 when casting product 20 is separated from resin casting mold 3.

Now, operations of the resin casting mold of the present embodiment, i.e. a method of casting a resin, will be described. First, as shown in FIG. 1, lower and upper molds 1 and 2 are opened. Next, the molds being open, a pot (not shown) is loaded with resin tablets (not shown). Also, a board 15 having a chip 17 mounted on it is positioned to be opposite to cavity 12. Subsequently, board 15 is sucked by suction mechanism 14 to be secured to upper mold 2.

Next, as shown in FIG. 2, lower and upper molds 1 and 2 are closed. The resin tablets (not shown) are then pressed upward by a plunger (not shown) and are melted to form a fluid resin. Subsequently, the fluid resin is pressed and thus poured into cavity 12 via runner 11, such that runner 11 and cavity 12 are filled with the fluid resin. The fluid resin is then cured to form a cured resin 19. Thus, a casting product 20 including board 15 and cured resin 19 is provided where bottom surface 13 of runner 11 and cavity 12 sticks to the lower surface of cured resin 19. It should be noted that block 7 remains fixed during the above steps.

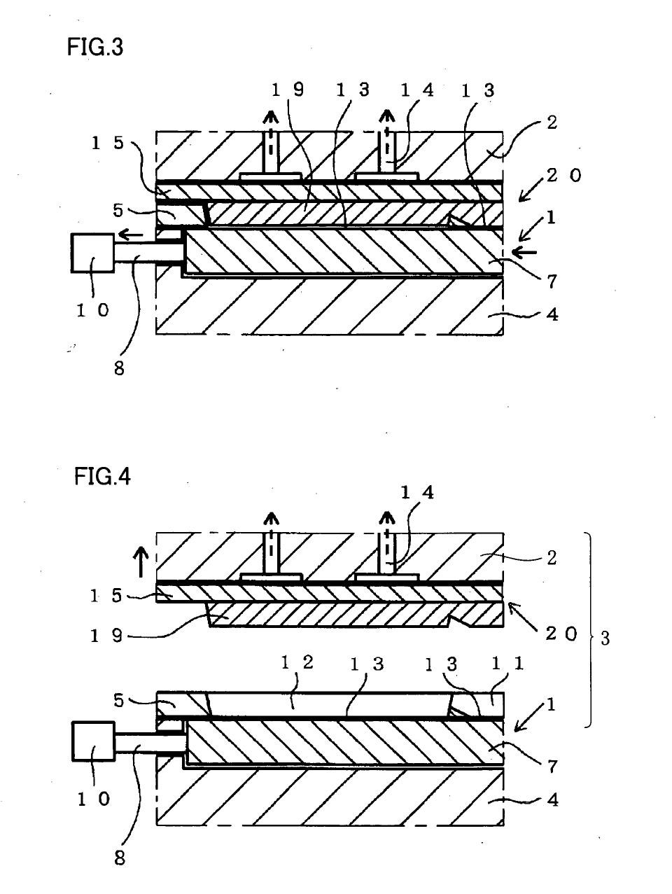

Subsequently, as shown in FIG. 3, with lower and upper molds 1 and 2 closed, driver mechanism 10 is employed to move rod 8 in a direction that lies along bottom surface 13 i.e. in a horizontal direction (to the left in the figures). Thus, an external, horizontal force is applied to block 7 secured to rod 8, such that block 7 also moves together with rod 8 in the same direction. Consequently, part of the upper surface of block 7 i.e. bottom surface 13 of runner 11 and cavity 12 moves in the same direction in which rod 8 is moved. Thus, a shearing stress is effected between bottom surface 13 and the lower surface of cured resin 19 sticking to it, resulting in a microscopic gap between bottom surface 13 and the lower surface of cured resin 19, that is, bottom surface 13 is separated from the lower surface of cured resin 19. In other words, cured resin 19 and bottom surface 13 transition from the sticking state to the unsticking state.

It should be noted that block 7 can be moved in any direction that lies along bottom surface 13, i.e. a horizontal direction, which may be to the left or to the right in the figures, departing from the plane of paper or the direction opposite thereto.

Preferably, block 7 is moved by an amount sufficient to separate cured resin 19 from bottom surface 13 in one movement. However, block 7 may also be moved repeatedly in the same direction or in the opposite directions, each time by an amount smaller than that sufficient to separate cured resin 19 from bottom surface 13.

Subsequently, as shown in FIG. 4, with board 15 being sucked and secured to upper mold 2, lower and upper molds 1 and 2 are opened. Since cured resin 19 has already been separated from bottom surface 13, casting product 20 can be easily removed from cavity 12 of lower mold 1 and lifted up as it is secured to upper mold 2. Casting product 20 is then transported by a transportation mechanism (not shown) to equipment for the following step. A prescribed test is performed on region 16 (see FIG. 1) in which one chip 17 is mounted as one unit, before cutting equipment is employed to cut casting product 20 along the phantom lines for shaping a grid to divide it into a plurality of packages corresponding to a plurality of regions 16.

The method of casting a resin of the present embodiment is characterized by using driver mechanism 10 to move block 7 when cured resin 19 providing casting product 20 has been formed, to separate the lower surface of cured resin 19 from bottom surface 13 of runner 11 and cavity 12. This provides the following advantages:

Resin casting mold 3 does not include any of an ejector mechanism and a mechanism for jetting high pressure fluid of conventional resin casting molds. This results in equipment including a resin casting mold 3 with a simpler structure and smaller size.

Further, the stress in the thickness direction of casting product 20 can be reduced. Thus, even a thin casting product 20 with a large major surface is less likely to be damaged than using a conventional resin casting mold in which casting product 20 is ejected in a direction crossing the cavity surface, i.e. a conventional resin casting mold having an ejector mechanism or a mechanism for jetting high pressure fluid, particularly for manufacturing a package for electronics by resin-sealing chip 17, such that crack, breaking of wire 18, improper connection and the like are prevented from occurring in casting product 20. Thus, the reliability and yield of the end product, i.e. electronic component, can be improved.

Moreover, driver mechanism 10 only needs to move block 7, which means that casting product 20 can be separated from cavity 12 more efficiently than using equipment including a conventional resin casting mold in which the entire resin casting mold is vibrated to separate a casting from the cavity surface. Furthermore, driver mechanism 10 can move block 7 with a force that is significantly larger than that of a piezoelectric material being deformed in a direction that lies along the cavity surface from the center of the cavity toward the outside. Accordingly, unlike equipment including a conventional resin casting mold in which a piezoelectric material is deformed in the direction described above, the present invention does not cause the problem that the cured resin is not separated from the cavity surface due to insufficient moving force.

### Second Embodiment

Now, referring to FIGS. 3 and 4, a resin casting mold and a method of casting a resin according to a second embodiment of the present invention will be described. The method of the present embodiment is characterized by opening lower and upper molds 1 and 2 during the step shown in FIG. 3, i.e. the step of using driver mechanism 10 to move block 7 in a horizontal direction (to the left in the figures).

Preferably, the opening of lower and upper molds 1 and 2 begins directly after block 7 begins to be moved in the case of a thinner casting product 20 with a larger major surface, i.e. when it is required to minimize the stress upon casting product 20 during the separation of casting product 20 from resin casting mold 3.

The method of casting a resin of the present embodiment described above achieves proper separation for casting product 20 since a shearing stress and a tensile stress act between bottom surface 13 and the lower surface of cured resin 19 with the lower surface of cured resin 19 sticking to bottom surface 13. That is, between bottom surface 13 and the lower surface of cured resin 19, a shearing stress caused by the movement of block 7 cooperates with a tensile stress resulting from the opening of the molds, and thus the stress upon casting product 20 can be reduced.

It should be noted that while the first and second embodiments described above illustrate a method of casting a resin for resin-sealing chips 17 mounted on a board 15 in their respective regions 16 divided by phantom lines for shaping a grid, the method of casting a resin according to the present invention is not limited thereto and may be applied to resin-sealing of a single chip mounted on a board 15.

Moreover, the resin casting mold and the method of casting a resin of the present invention may also be applied to resin casting in general besides resin-sealing. The resin casting mold and the method of casting a resin of the present invention may also be applied to injection molding or compression molding besides transfer molding.

Further, the first and second embodiments provide runner 11, cavity 12 and block 7 on lower mold 1. However, the resin casting mold of the present invention is not limited to the above arrangement and may provide a runner 11, a cavity 12 and a block 7 on upper mold 2. The resin casting mold of the present invention may also provide a runner 11, a cavity 12 and a block 7 on each of lower and upper molds 1 and 2. Moreover, the present invention is not limited to an arrangement with a lower mold 1 and an upper mold 2, and can be applied to any resin casting mold having two opposite molds.

Preferably, in the resin casting mold of the present invention, block 7 is formed of a material that exhibits good separation properties or bottom surface 13 is provided with a film that exhibits good separation properties. Resin casting mold 3 may be formed of any material selected from a metal material such as tool steel, an inorganic material such as ceramics and an organic material.

It is desirable that the lower surface of opposing member 5, which comes into contact with block 7, is formed by a matter with smaller coefficients of friction, which allows block 7 to be moved smoothly with a small force. Matters with smaller coefficients of friction include, for example, polytetrafluoroethylene (PTFE).

In the first and second embodiments described above, driver mechanism 10 is an actuator constructed of, for example, an air cylinder or a hydraulic cylinder employing fluid pressure, although an actuator that can be driven by electromagnetic force (push-pull solenoid or the like), or a piezoelectric element may also be used. Driver mechanism 10 may also be a mechanism for converting a rotational movement to a reciprocating movement (a motor and a cam, for example). Also, a rod 8 secured to block 7 is used to apply an external force to block 7, although the rod may be replaced by a hammer-like member that is independent from block 7.

Driver mechanism 10 may apply an external force to block 7 in one of the following manners to move block 7: momentarily, intermittently, and continuously for a certain period of time. The time during which driver mechanism 10 applies an external force to block 7, the number of applications, the magnitude of the external force and the like can be optimized based on the degree of sticking of cured resin 19 to bottom surface 13, the contact area and the like.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A resin casting mold for manufacturing a casting product including a cured resin produced by curing a fluid resin filling a cavity, the mold comprising:
a block providing a bottom surface of said cavity; and
a driver mechanism for applying a force to said block to move said block in a direction that lies along said bottom surface,
wherein said driver mechanism moves said block when said cured resin has been formed to separate said cured resin from said bottom surface.

2. The resin casting mold according to claim 1,
wherein said driver mechanism moves said block while said resin casting mold is being opened.

3. A method of casting a resin, comprising the steps of:
filling a cavity with a fluid resin;
curing said fluid resin; and,
by moving a block providing a bottom surface of said cavity in a direction that lies along said bottom surface, separating said cured resin from said bottom surface.

4. The method of casting a resin according to claim 3,
wherein said step of separating moves said block while said resin casting mold is being opened.
